(19) United States
(12) Patent Application Publication
(10) Pub. No.: US 2008/0296412 A1
(43) Pub. Date: Dec. 4, 2008

(54) Fuel injector having a flow passage insert

(75) Inventors: Dennis H. Gibson, Chillicothe, IL (US); Jinhui Sun, Bloomington, IL (US)

Correspondence Address: Caterpillar Inc.;Intellectual Property Dept., AH 9510, 100 N.E. Adams Street, PEORIA, IL, 61629-9510, US

(73) Assignee: Caterpillar Inc., Peoria, IL (US)

(21) Appl. No.: 11/809,708

(22) Filed: Jun. 1, 2007

(51) Int. Cl. F02M 61/16

(52) U.S. Cl. 239/533.2

(57) ABSTRACT

Fuel injectors having control passages with relatively large volumes may have limited responsiveness. The injector described herein may help to reduce the control passage volume and improve responsiveness by providing a chamber for receiving a fluid, a control valve, a flow passage, and an insert. The control valve may be moveable between a first position and a second position. The flow passage may extend between the control valve and the chamber, and the flow passage may define a first volume. The insert may be located within the flow passage, and the insert may occupy a second volume. The placement of the insert within the flow passage reduces the volume of the flow passage that is available to receive the fluid to a third volume equal to the first volume less the second volume.

### TECHNICAL FIELD

The present invention relates generally to fuel injectors. More particularly, the present invention relates to inserts for use in one or more of the flow passages of fuel injectors.

### BACKGROUND

In order to meet the increasingly stringent emissions regulations, diesel engine manufacturers are exploring different techniques for reducing the regulated components of diesel engine emissions. One approach used to help achieve the reduced emissions is to utilize multiple injections of fuel into the combustion chamber during any particular combustion event. For example, manufacturers currently use a number of different injection strategies, some of which include a pre-injection, a main injection, a post injection, or different combinations of these or other injection types. While the appropriate injection strategy to use in a particular situation may depend on a variety of different factors, one factor that has the potential to limit the availability of any particular multiple injection strategy is the responsiveness of the fuel injector used to perform the injections. If the fuel injector is not responsive enough, its ability to consistently inject small amounts of fuel or to perform more than one injection within a small window of time may be severely limited.

In many cases, control over the injection events of the injector is accomplished hydraulically, using fuel or some other fluid (e.g., engine oil or other actuation fluid) to selectively apply a closing force to the needle valve of the fuel injector. Often, a valve is used to control the flow of fluid to, and/or from, a control chamber that is formed within the injector. The control chamber is configured to receive the fluid in a way that enables the pressure of the fluid to apply a closing force to the needle valve, or to a member acting on the needle valve. The fluid is usually directed between the valve and the control chamber through one or more control passages. However, the greater the volume of these control passages, the more fluid it takes to fill them and the more “sluggish” the injector may become. Due to manufacturing limitations, such the limited ability to create a hole or bore of a small diameter over a relative long distance, it is often difficult to reduce the diameter of the control passages beyond a certain point, so other volume reducing methods have been used.

Injector manufacturers have utilized at least two different methods or techniques to keep the volume of the control passages low. One technique reduces the volume of the control passages by placing both the control valve and the control valve actuator (e.g., solenoid or piezo-electric actuator) inside the injector body, which allows the control valve to be located near the control chamber. The placement of the control valve near the control chamber helps to reduce the length, and therefore the volume, of the control passages. Although effective to reduce the volume of the control passages, the placement of the control valve actuator within the injector (as opposed to on the top of the injector) often presents packaging and cost challenges for the valve and actuator. Another technique used by manufacturers reduces the volume of the control passage by extending the length of the needle valve so that the control chamber formed at the top of the needle valve is close to the top of the injector, where the control valve and control valve actuator are located. The drawback to this technique is that the extension of the needle valve increases the overall weight of the needle valve, making the rapid movement of the valve more difficult due to greater inertia forces.

UK Patent Application No. GB 2,356,020 (“the '020 patent”), filed Oct. 27, 2000, discloses an arrangement that is intended to serve as a pressure wave damping device that includes the use of an insert within a bore that couples a control chamber with a resonance chamber. Although this arrangement may be effective to provide pressure wave dampening, the insert is not located in a position that would have an effect on the volume of the control passage.

It would be desirable to provide a fuel injector that overcomes one or more of the deficiencies discussed above.

### SUMMARY

According to one exemplary embodiment, an injector for injecting a fluid comprises a chamber for receiving the fluid, a control valve, a flow passage, and an insert. The control valve may be moveable between a first position and a second position. The flow passage may extend between the control valve and the chamber, and the flow passage may define a first volume. The insert may be located within the flow passage, and the insert may occupy a second volume. The placement of the insert within the flow passage reduces the volume of the flow passage that is available to receive the fluid to a third volume equal to the first volume less the second volume.

According to another exemplary embodiment, a fuel injector comprises a body, a control chamber, a control valve, a control passage, a pressure chamber, a needle valve, and an insert. The body may include a fuel inlet, a low pressure outlet, and at least one orifice for the injection of fuel. The control valve may be moveable between a first position in which the control chamber is fluidly coupled to the fuel inlet and a second position in which the control chamber is fluidly coupled to the low pressure outlet. The control passage may extend between the control valve and the control chamber, and the control passage may define a first volume. The pressure chamber may be fluidly coupled to the fuel inlet. The needle valve member may have a first end acted upon by pressurized fluid within the pressure chamber and a second end acted upon by pressurized fluid within the control chamber. The needle valve member may be moveable between a first position in which the at least one orifice is fluidly disconnected from the pressure chamber and a second position in which the at least one orifice is fluidly coupled to the pressure chamber. The insert may be located within the control passage, and the insert may occupy a second volume. The placement of the insert within the control passage reduces the volume of the control passage that is available to receive fuel to a third volume equal to the first volume less the second volume.

According to another exemplary embodiment, a method of operating a fuel injector having a control chamber configured to selectively receive pressurized fluid to apply a closing force to a needle valve member comprises the step of selectively actuating a control valve between a first position and a second position. The method also comprises the step of moving fluid between the control chamber and the control valve through a flow passage having an insert located therein. The insert may consume at least 25 percent of the total volume defined by the flow passage.

### BRIEF DESCRIPTION OF THE DRAWINGS

FIG. 1 is a schematic illustration of a fuel system according to one exemplary embodiment.

FIG. 2 is cross-sectional side view of a fuel injector according to one exemplary embodiment of the fuel system of FIG. 1.

FIG. 3 is a schematic illustration of the fuel injector of FIG. 2.

FIG. 4 is a cross-sectional end view of an insert, according to one exemplary embodiment, of the fuel injector of FIG. 2.

FIG. 5 is a cross-sectional side view of the insert of FIG. 4 taken along line A-A.

FIG. 6 is a cross-sectional end view of an insert, according to another exemplary embodiment, of the fuel injector of FIG. 2.

### DETAILED DESCRIPTION

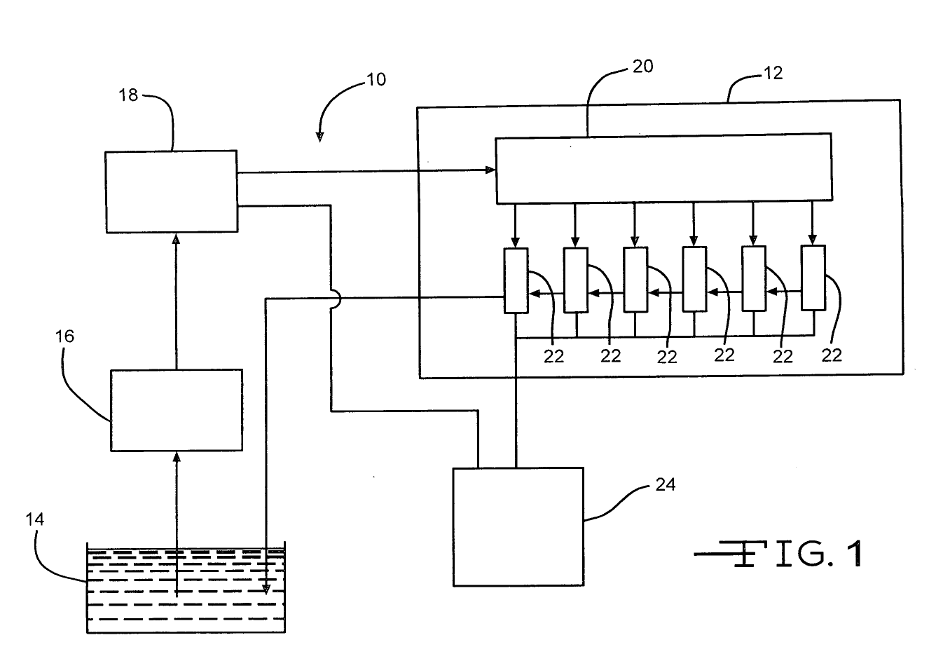

Referring to FIG. 1, a fuel system 10 is shown according to one exemplary embodiment. Fuel system 10 is the system of components that cooperate to deliver fuel (e.g., diesel, gasoline, heavy fuel, etc.) from a location where fuel is stored to the combustion chamber(s) of an engine 12 where it will combust and where the energy released by the combustion process will be captured by engine 12 and used to generate a mechanical source of power. Although depicted in FIG. 1 as a fuel system for a diesel engine, fuel system 10 may be the fuel system of any type of engine (e.g., internal combustion engine such as a diesel or gasoline engine, a turbine, etc.). According to one exemplary embodiment, fuel system 10 includes a tank 14, a transfer pump 16, a high-pressure pump 18, a common rail 20, fuel injectors 22, and an electronic control module (ECM) 24.

Tank 14 is a storage container that stores the fuel that fuel system 10 will deliver. Transfer pump 16 pumps fuel from tank 14 and delivers it at a generally low pressure to high-pressure pump 18. High-pressure pump 18, in turn, pressurizes the fuel to a high pressure and delivers the fuel to common rail 20. Common rail 20, which is intended to be maintained at the high pressure generated by high-pressure pump 18, serves as the source of high-pressure fuel for each of fuel injectors 22. Each fuel injector 22 is continuously fed fuel from common rail 20 such that any fuel injected by a fuel injector 22 is quickly replaced by additional fuel supplied by common rail 20. ECM 24 is a control module that receives multiple input signals from sensors associated with various systems of engine 12 (including fuel system 10) and indicative of the operating conditions of those various systems (e.g., common rail fuel pressure, fuel temperature, throttle position, engine speed, etc.). ECM 24 uses those inputs to control, among other engine components, the operation of high-pressure pump 18 and each of fuel injectors 22. The purpose of fuel system 10 is to ensure that the fuel is constantly being fed to engine 12 in the appropriate amounts, at the right times, and in the right manner to support the operation of engine 12.

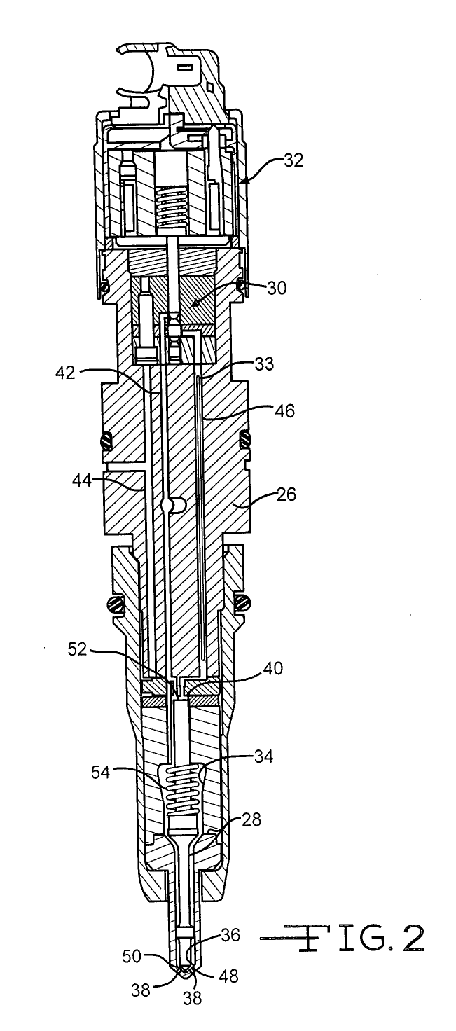

Referring now to FIG. 2, each fuel injector 22 is located within engine 12 in a position that enables it to inject high-pressure fuel into a combustion chamber of engine 12 (or into a pre-chamber or a port upstream of the combustion chamber in some cases) and generally serves as a metering device that controls when fuel is injected into the combustion chamber, how much fuel is injected, and the manner in which the fuel is injected (e.g., the angle of the injected fuel, the spray pattern, etc.). According to one exemplary embodiment, each fuel injector 22 includes a body 26, a needle valve member 28, a control valve 30, an actuator 32, and an insert 33.

Body 26 generally forms the basic structure of fuel injector 22, including the structures that receive other components, flow passages that allow for the flow of fuel from one portion of fuel injector 22 to another, and the structures that maintain fuel injector 22 in an assembled condition. Body 26 may be an assembly constructed from multiple different parts, pieces, or elements that cooperate together to form the general structure of fuel injector 22. According to one exemplary embodiment, body 26 includes a pressure chamber 34, a needle valve seat 36, orifices 38, a control chamber 40, a supply passage 42, a drain passage 44, and a control passage 46.

According to one exemplary embodiment, pressure chamber 34 is a chamber or cavity formed within body 26 that is fluidly coupled to common rail 20 via supply passage 42 and that receives needle valve member 28 in a manner that allows needle valve member 28 to reciprocate between an open position and a closed position. Thus, pressure chamber 34 essentially serves as a reservoir for high pressure fuel that is ready to be injected. Needle valve seat 36 is located within pressure chamber 34 and serves as a surface against which needle valve member 28 seats or seals when it is in the closed position to stop fluid from escaping from pressure chamber 42. Orifices 38 are holes in body 26, located near needle valve seat 36, that allow fluid to escape from pressure chamber 34 when needle valve member 28 is in the open position.

According to one exemplary embodiment, control chamber 40 is a chamber or cavity that is configured to cooperate with needle valve member 28 such that the pressure of the fluid within control chamber 40 applies a force to needle valve member 28 (either directly or indirectly through an intermediate member) that urges needle valve member 28 into the closed position. The selective application of force to needle valve member 28 through pressurized fuel within control chamber 40 can be used to control the movement of the needle valve member 28 between the open and closed positions. According to one exemplary embodiment, a portion of needle valve member 28 forms at least one of the walls that defines control chamber 40, such that a pressurized fluid within control chamber 40 urges that portion of the needle valve member 28 outward. Control chamber 40 is fluidly coupled to supply passage 42 and to control passage 46. An appropriately sized flow restriction may be provided in one or both of supply passage 42 and control passage 46 to control the rate of flow of fluid into and/or out of control chamber 40.

Supply passage 42, drain passage 44, and control passage 46 are each flow passages, bores, or drillings that are located within fuel injector 22 and serve to direct fluid to certain parts of fuel injector 22. According to one exemplary embodiment, supply passage 42 serves to direct fluid from common rail 20 to pressure chamber 34, to control chamber 40 (through a flow restriction), and to control valve 30; drain passage 44 serves to direct fluid from control valve 30 to tank 14 (e.g., a low pressure drain); and control passage 46 serves to direct fluid between control valve 30 and control chamber 40. Although the diameter of each flow passage may be varied, depending on the length and location of each flow passage, the smallest available diameter of a particular flow passage may be limited by manufacturing considerations. For example, a long passage may need to have a larger minimum diameter than a shorter passage. According to other various exemplary and alternative embodiments, the particular path a flow passage takes through fuel injector 22 may be varied. For example, control passage 46 may be configured to maximize the distance over which it follows a straight path. As described in more detail below, this may facilitate the use of a longer (and therefore larger volume) insert 33.

Needle valve member 28 is a rigid member that moves between an open position and a closed position to selectively permit the pressurized fluid from within pressure chamber 34 to be injected into a combustion chamber through orifices 38. According to one exemplary embodiment, needle valve member 28 has a first end that includes a seating surface 48 and a pressure surface 50, and a second opposite end that includes a pressure surface 52. Seating surface 48 cooperates with needle valve seat 38 of body 26 such that when needle valve member 28 is in the closed position, any flow of fluid out of orifices 38 is substantially prevented. Pressure surface 50 is a surface of needle valve member 28 upon which the pressurized fluid within pressure chamber 34 acts when needle valve member 28 is in the closed position to apply a needle opening force that urges needle valve member 28 into the open position. Similarly, pressure surface 52 is a surface on the opposite end of needle valve member 28 upon which the fluid within control chamber 40 acts to apply a needle closing force that urges needle valve member 28 into the closed position. Because the force acting on pressure surface 50 opposes the force acting on pressure surface 52, the areas of pressure surfaces 50 and 52 are configured so that needle valve member 28 will be retained in the closed position when the fluid pressure within control chamber 40 is approximately the same as the fluid pressure within pressure chamber 34. A biasing member, shown as a spring 54, is coupled between needle valve member 28 and a portion of pressure chamber 34 and applies a biasing force to needle valve member 28 that urges it into the closed position. The biasing force provided by spring 54, which increases the total needle closing force, is taken into account in the configuration of the areas of pressure surfaces 50 and 52. According to various alternative and exemplary embodiments, the areas of pressure surfaces 50 and 52 may vary relative to one another, and the biasing force of spring 54 may be varied, but the areas and the biasing force of spring 54 should be such that needle valve member 28 can be maintained in the closed position when the fluid pressure within control chamber 40 is approximately the same as the fluid pressure within pressure chamber 34. Similarly, the biasing force provided by spring 54 should be small enough that the needle opening force applied to needle valve member 28 by the pressurized fluid within pressure chamber 34 can overcome the biasing force of spring 54.

Referring now to FIGS. 2 and 3, control valve 30 is a valve that serves to selectively couple control passage 46 to supply passage 42 or drain passage 44. Stated differently, control valve 30 serves to selectively couple control chamber 40 to either common rail 20 or tank 14. According to one exemplary embodiment, control valve 30 is a three-way valve that is moveable between a drain position 56 and a pressurization position 58. Control valve 30 is coupled to actuator 32, which controls the movement of control valve 30 between drain position 56 and pressurization position 58. In drain position 56, control valve 30 fluidly couples control passage 46, and therefore control chamber 40, to drain passage 44, which ultimately leads to tank 14. In pressurization position 58, control valve 30 fluidly couples control passage 46, and therefore control chamber 40, to supply passage 42, which is coupled to common rail 20. Thus, when control valve 30 is in drain position 56, control chamber 40 is fluidly coupled to tank 14, which in turn causes the pressure of the fluid within control chamber 40 to drop below the pressure of the fluid within pressure chamber 34. The drop in fluid pressure in control chamber 40 then allows the fluid in pressure chamber 34 to force needle valve member 28 into the open position. When control valve 30 is in pressurization position 58, control chamber 40 is fluidly coupled to supply passage 42, which then causes the pressure of the fluid within control chamber 40 to increase, for example to approximately the same pressure as the pressure of the fluid within pressure chamber 34. The approximate equalization of the fluid pressures in control chamber 40 and in pressure chamber 34, in combination with the biasing force provided by spring 54 and the relative areas of pressure surfaces 50 and 52, then creates a net downward force that acts on needle valve member 28 to move it into the closed position. According to various alternative and exemplary embodiments, the control valve may take any one of a variety of different configurations. For example, the control valve may be a two-way valve, a spool valve, or any other type of valve. The control valve could also be made up of one valve element, or more than one valve element (e.g., it essentially could be two or more valve elements working together to accomplish the fluid connections described above).

Actuator 32 is a device that is coupled to control valve 30 and that serves to selectively move control valve 30 between drain position 56 and pressurization position 58. According to one exemplary embodiment, actuator 32 is an electronically controlled device that generates movement in response to an electric signal provided by ECM 24. According to various exemplary and alternative embodiments, the electronically controlled device may comprise a solenoid and a corresponding armature, a piezo-electric actuator, or any other suitable actuation device that can be used to control the movement of the control valve.

Referring generally to FIGS. 2 through 6, insert 33 is a volume occupying structure, element, member, or core that is located within control passage 40 and that is intended to consume or occupy at least a portion of the volume defined by control passage 40. By consuming some of the volume defined by control passage 40, insert 33 reduces the effective volume of control passage 40, which can be defined as the volume within control passage 40 that is available for a fluid to occupy. The reduction of the effective volume of control passage 40 is believed to improve the hydraulic response of needle valve member 28, and therefore fuel injector 22. According to various exemplary and alternative embodiments, insert 33 may take any one of a variety of different shapes and configurations, and may consume different portions of the total volume defined by control passage 40. For example, according to various exemplary and alternative embodiments, insert 33 may consume between approximately 25% and 75% of the total volume of control passage 40, and more particularly between approximately 30% and 50% of the total volume. According to other exemplary and alternative embodiments, insert 33 may consume any portion of the total volume of control passage 40. According to other various exemplary and alternative embodiments, the length of insert 33 is approximately equal to the length of the largest straight portion of control passage 40. According to other exemplary and alternative embodiments, the length of insert 33 may be any portion of the length of the largest straight portion of control passage 40. According to still other exemplary and alternative embodiments, the insert may be configured such that it can be inserted into one or more portions of control passage 46 that are not straight. According to other exemplary and alternative embodiments, insert 33 may extend into control chamber 40 and consume some of the total volume of control chamber 40.

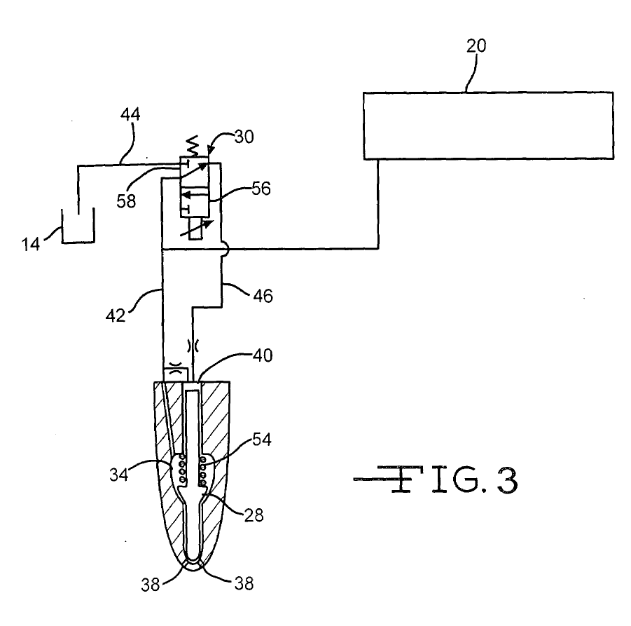

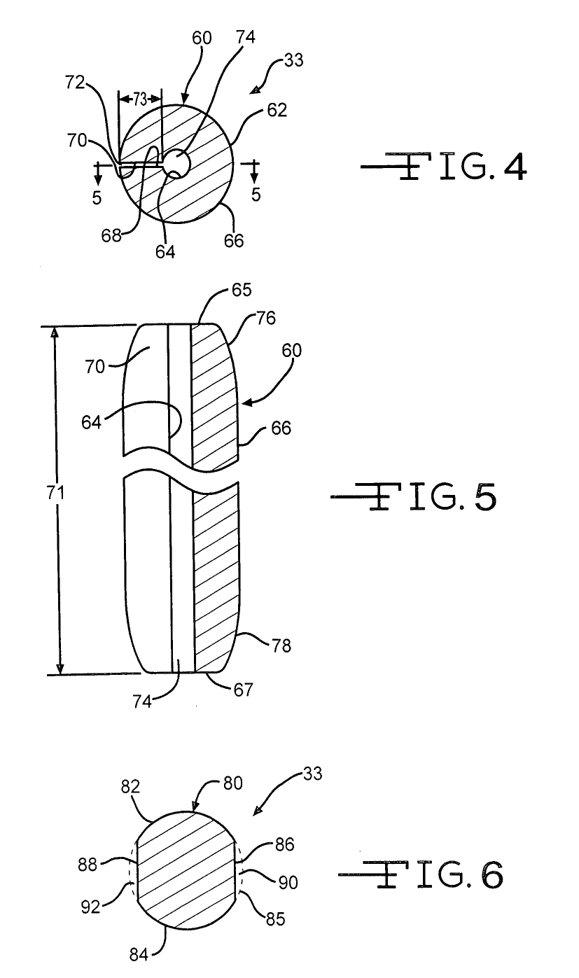

Referring now to FIGS. 4 and 5, insert 33 may, according to one exemplary embodiment, take the form of a member 60. According to one exemplary embodiment, member 60 is constructed from a substantially flat, rectangular piece of material 62 that has been rolled to assume a substantially cylindrical shape. When flat, piece 62 includes opposite surfaces 64 and 66, opposite edges 68 and 70, opposite ends 65 and 67, a length 71, and a thickness 73. Once piece 62 has been rolled into the cylindrical shape, edges 68 and 70 generally face one another and are spaced apart to define a relatively small gap 72. Surface 64 defines an internal passage 74 that extends the length of member 60, while surface 66 defines the outer diameter of member 60. In this configuration, the material of member 60 consumes a significant portion of the volume of control passage 46 when member 60 is inserted into control passage 46. The only volume that remains for fluid to occupy (i.e., the effective volume of control passage 46) is the relatively small volume defined by internal passage 74 and the relatively small volume defined by gap 72. To facilitate insertion of member 60 into control passage 46 and to reduce the likelihood of creating burrs during insertion, outer surface 66 may include transition regions 76 and 78 near ends 65 and 67, respectively. According to one exemplary embodiment, transition regions 76 and 78 are generally straight, tapered regions that gradually increase in diameter as they extend toward the center of member 60. According to other exemplary and alternative embodiments, the transition regions may assume any one of a variety of different shapes and configurations. For example, the transition regions may be radiused, curved, concave, convex, partially straight, partially curved, stepped, and/or otherwise shaped and configured. According to other alternative and exemplary embodiments, the member may only not include any transition regions or it may include only one transition region.

According to various exemplary and alternative embodiments, the volume consumed by member 60 can be adjusted by altering length 71 of member 60. Thus, to achieve the smallest effective volume of control passage 46, length 71 should be maximized. Similarly, to achieve a larger effective volume of control passage 46, length 71 should be reduced from the maximum length. According to other various exemplary and alternative embodiments, the volume consumed by member 60 can be adjusted by altering thickness 73 of member 60. Thus, to achieve the smallest effective volume of control passage 46, thickness 73 should be maximized. Similarly, to achieve a larger effective volume of control passage 46, thickness 73 should be reduced from the maximum thickness. According to still other various exemplary and alternative embodiments, the volume consumed by member 60 can be adjusted by changing the shape of member 60. For example, instead of having a substantially circular cross-section, member 60 could have an oval-like cross section that could create volumes available for fluids to occupy not only within the oval-like member and the gap, but also at certain areas between the outer surface of the oval-like member and the surface defining control passage 46, due to the fact that the cross-sectional shape of the oval-like member does not match that of control passage 46.

Referring now FIG. 6, insert 33 may, according to another exemplary embodiment, take the form of a member 80. According to one exemplary embodiment, member 80 is a structure having two opposed arcs 82 and 84, which, if extended would define a circle 85. Arcs 82 and 84 are separated on both ends by two opposing flat portions 86 and 88 that are defined by two parallel chords of circle 85. In this configuration, member 80 will consume all of the corresponding volume of control passage 46 except the volume defined by the space between flat portions 86 and 88 and the corresponding inner surfaces of control passage 46. Thus, the effective volume of control passage 46 can be adjusted by adjusting the distance flat portions 86 and 88 are from the center of circle 85. According to various alternative and exemplary embodiments, the flat portions, which define cutouts 90 and 92 of circle 85, may be replaced by curved portions or triangular portions; by grooves, slots, or channels; or by other portions or surfaces defining any one of a variety of different cutout shapes. According to other alternative and exemplary embodiments, the path of each cutout along the length of the member may be straight, it may be curved, it may be helical, or it may take any other path, as long as the path allows fluid to flow around or through the insert. As with member 60, the volume consumed by member 80 can be adjusted by altering the length of member 80. The consumed volume may also be adjusted by altering the shape of the cutouts and/or the number of cutouts. By making these adjustments, member 80 may assume one of a plurality of different configurations and may be adjusted to achieve the desired effective volume within control passage 46.

According to various alternative and exemplary embodiments, insert 33 may be made from any one of a variety of different materials. For example, the insert may be made from various metals, alloys, polymers, ceramics, or other suitable materials. According to other various alternative and exemplary embodiments, the insert may be made from one or more of a variety of different manufacturing techniques. For example, depending at least in part on the material or materials from which the insert is constructed, the insert may be molded, cast, machined, forged, extruded or otherwise manipulated to achieve its final shape and form. According to other exemplary and alternative embodiments, the insert may be inserted or placed within control passage 46 in one of a variety of different ways. For example, the insert may be configured to fit tightly within control passage 46 and may be pressed fitted with control passage 46; the insert may be cooled (e.g., through the use of cryogenic techniques) and then placed within control passage 46 where it expands into tight contact with the walls of control passage 46 as it warms back up and expands; the insert may be configured to fit relatively loosely or “float” within control passage 46 and may simply be inserted into control passage 46; the insert may engage the surface defining control passage 46 along the length of the insert and/or engage a surface (e.g., a point at which control passage 46 curves) at its ends; the insert may engage control passage 46 continuously or intermittently; and/or the insert may be placed or inserted into, or retained within, control passage 46 using one or more of a variety of other techniques. According to other exemplary and alternative embodiments, the insert may be configured to operate with different fuels (e.g., ultra low sulfur diesel fuel, JP8, bio-diesel, etc.) or with one or more of a plurality of other fluids.

### INDUSTRIAL APPLICABILITY

As discussed above, fuel injectors 22 are used to inject high-pressure fuel into the combustion chambers of engine 12 (or pre-chambers or ports upstream of the combustion chamber in some cases) and generally serve as metering devices that control when fuel is injected into the combustion chamber, how much fuel is injected, and the manner in which the fuel is injected. According to one exemplary embodiment, fuel injector 22 operates in the following manner. Fuel injector 22 receives pressurized fuel from common rail 20. Within fuel injector 22, supply passage 42 directs the pressurized fuel to pressure chamber 34, control chamber 40, and control valve 30. Within pressure chamber 34, the pressurized fuel acts upon pressure surface 50 of needle valve member 28 and applies a needle opening force to needle valve member 28 that urges needle valve member 28 into the open position. Within control chamber 40, the pressurized fuel acts upon pressure surface 52 of needle valve member 28 and applies a needle closing force to needle valve member 28 that urges needle valve member 28 into the closed position. In addition to the forces acting on needle valve member 28 from the pressurized fuel with pressure chamber 34 and control chamber 40, spring 54 is coupled to needle control valve member 28 in such a way that it applies an additional needle closing force to needle valve member 28.

Spring 54, pressure surface 50, and pressure surface 52 are configured to cooperate with one another such that when the pressure of the fuel within pressure chamber 34 is approximately equal to the pressure of the fuel within control chamber 40, the total resultant force acting on needle valve member 28 is a needle closing force that moves needle valve member 28 into, or maintains needle valve member 28 in, the closed position. When needle valve member 28 is in the closed position, needle valve member 28 prevents (or substantially prevents) any flow of fuel out of orifices 38. However, when the pressure of the fuel within control chamber 40 is reduced by a sufficient amount, the total needle closing force provided by the fuel within control chamber 40 and spring 54 will be reduced to the point where the needle opening force provided by the pressurized fuel within pressure chamber 34 (which will normally be at approximately the pressure of common rail 20) is greater than the total needle closing force. When this occurs, needle valve member 28 moves into the open position and pressurized fuel from pressure chamber 34 is allowed to flow out of orifices 38 and is injected into a combustion chamber (either directly or indirectly) of engine 12.

Control valve 30 generally serves to control the injection of fuel out of fuel injector 22 (e.g., the flow of fuel out of orifices 38) by controlling the pressure of the fuel within control chamber 40. To control the pressure within control chamber 40, control valve 30 moves between pressurization position 58 and drain position 56 to selectively couple control passage 46 and control chamber 40 to supply passage 42 (which is fluidly coupled to the pressurized fuel from common rail 20) or drain passage 44 (which is fluidly coupled with tank 14), respectively. To start injection, control valve 30 moves from pressurization position 58 to drain position 56. This has the effect of coupling control chamber 40 to tank 14, which allows the needle opening force acting on needle valve member 28 to overcome the needle closing forces, which moves needle valve member 28 into the open position. To end injection, control valve 30 moves from drain position 56 to pressurization position 58. This has the effect of coupling control chamber 40 to common rail 20 (via both supply passage 42, which is always fluidly coupled to control chamber 40, and control passage 46), which allows the needle closing forces acting on needle valve member 28 to overcome the needle opening force, which moves needle valve member 28 into the closed position. Actuator 32, which is controlled by ECM 24, controls the movement of control valve 30 between pressurization position 58 and drain position 56.

One of the factors that may limit the ability of a fuel injector to provide controllable and consistent, low volume injections with small dwell intervals is the ability to quickly stop an injection event. One significant factor that influences how quickly an injection event can be stopped is how quickly the pressure of the fuel within control passage 46 and control chamber 40 can be increased. The total volume of fuel that needs to be increased to the greater pressure, in turn, influences how quickly the pressure can be increased. In general, the greater the volume of fuel that needs to be increased to a greater pressure, the longer it will take to pressurize that fuel to a particular increased pressure, and the longer it will take to stop an injection.

According to the present disclosure, an insert 33 that occupies a certain volume may be inserted into, or otherwise located within, control passage 46 to provide an effective volume of control passage 46 that is less than its actual volume. The use of insert 33 is a relatively simple, robust, and inexpensive way to reduce the volume of fuel that is needed to fill up control passage 46 and control chamber 40, and thereby improve the responsiveness of fuel injector 20. According to various exemplary and alternative embodiments, the insert may be a relatively low cost component and may be easily inserted into fuel injector 22 as fuel injection 22 is being assembled. The use of insert 33 may also provide more design flexibility by making it more feasible to place the control valve (and the corresponding actuator) in a location that is not in close proximity to the control chamber. Thus, through the use of insert 33, any need to move the control valve and corresponding actuator to an internal location within the fuel injector that is relatively close to the control chamber may be avoided. Similarly, any need to extend the length of the needle valve member so that the control chamber can be located proximate a control valve and corresponding actuator that are located at the top of the fuel injector may also be avoided.

It is important to note that the construction and arrangement of the elements of the fuel injector and inserts as shown in the exemplary and alternative embodiments is illustrative only. Although only a few embodiments of the recited subject matter have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, orientations, etc.) without materially departing from the novel teachings and advantages of the subject matter recited. For example, elements shown as integrally formed may be constructed of multiple parts or elements shown as multiple parts may be integrally formed, the operation of the interfaces (e.g., seating surfaces, valve positions, etc.) may be reversed or otherwise varied, and/or the length, width, or thickness of the structures and/or members or connectors or other elements of the system may be varied. It should be noted that the elements and/or assemblies of the fuel injector, including the insert, may be constructed from any of a wide variety of materials that provide sufficient strength or durability, in any of a wide variety of textures and combinations, and through any one or more of a variety of suitable manufacturing process. It should also be noted that the insert may be used in association with any one of a variety of different passages within a fuel injector; in association with a variety of different types of fuel injectors (including, without limitation, mechanically or hydraulically actuated unit injectors); in association with any one of a wide variety of other applications such as different hydraulic components, including without limitation fuel pumps, hydraulic valve systems used to control a portion of an engine's valvetrain, etc.; or for a variety of different purposes. Accordingly, all such modifications are intended to be included within the scope of the present disclosure. Other substitutions, modifications, changes and omissions may be made in the design, operating conditions and arrangement of the exemplary and alternative embodiments without departing from the spirit of the recited subject matter.

What is claimed is:

1. An injector for injecting a fluid comprising:
a chamber for receiving the fluid;
a control valve moveable between a first position and a second position;
a flow passage extending between the control valve and the chamber, the flow passage defining a first volume; and
an insert located within the flow passage, the insert occupying a second volume;
wherein the placement of the insert within the flow passage reduces the volume of the flow passage that is available to receive the fluid to a third volume equal to the first volume less the second volume.

2. The injector of claim 1, wherein the chamber is a control chamber.

3. The injector of claim 1, wherein the flow passage is a control passage.

4. The injector of claim 3, further comprising a needle valve member having a first end, to which the fluid within the control chamber applies a force, and a second end.

5. The injector of claim 4, further comprising a pressure chamber for receiving the fluid and wherein the second end of the needle valve member is exposed to the fluid within the pressure chamber.

6. The injector of claim 1, wherein the second volume is at least 25 percent of the first volume.

7. The injector of claim 1, wherein the insert is a substantially cylindrical member including at least one longitudinal cutout that permits the fluid to flow around the insert.

8. The injector of claim 7, wherein the insert includes two opposing longitudinal flats, the two flats forming chordal cutouts of the cylindrical member.

9. The injector of claim 1, wherein the insert defines an internal passage that permits fluid to flow through the insert.

10. The injector of claim 9, wherein the insert is a substantially rectangular piece of material rolled into a tube.

11. The injector of claim 1, wherein the insert is straight.

12. The injector of claim 1, wherein the insert has a first end near the control chamber and a second opposite end, and wherein at least one of the first end and the second end is tapered.

13. The injector of claim 1, wherein the control passage includes a straight portion, and wherein the length of the insert is approximately equal to the length of the straight portion of the control passage.

14. The injector of claim 1, wherein the insert is metal.

15. A fuel injector comprising:
a body including a fuel inlet, a low pressure outlet, and at least one orifice for the injection of fuel;
a control chamber;
a control valve moveable between a first position in which the control chamber is fluidly coupled to the fuel inlet and a second position in which the control chamber is fluidly coupled to the low pressure outlet;
a control passage extending between the control valve and the control chamber, the control passage defining a first volume;
a pressure chamber fluidly coupled to the fuel inlet;
a needle valve member having a first end acted upon by pressurized fluid within the pressure chamber and a second end acted upon by pressurized fluid within the control chamber, the needle valve member being moveable between a first position in which the at least one orifice is fluidly disconnected from the pressure chamber and a second position in which the at least one orifice is fluidly coupled to the pressure chamber; and
an insert located within the control passage, the insert occupying a second volume;
wherein the placement of the insert within the control passage reduces the volume of the control passage that is available to receive fuel to a third volume equal to the first volume less the second volume.

16. The fuel injector of claim 15, wherein the insert is a substantially cylindrical member including at least one longitudinal cutout that permits the fluid to flow around the insert.

17. The fuel injector of claim 15, wherein the insert defines an internal passage that permits fluid to flow through the insert.

18. The fuel injector of claim 15, wherein the insert has a first end proximate the control chamber and a second opposite end, and wherein at least one of the first end and the second end is tapered.

19. The fuel injector of claim 15, wherein the control passage includes a straight portion, and wherein the length of the insert is approximately equal to the length of the straight portion of the control passage.

20. The fuel injector of claim 15, wherein the insert is configured to be press-fitteed into the control passage.

21. The fuel injector of claim 15, wherein the insert is metal.

22. The fuel injector of claim 15, wherein the second volume is at least 25% of the first volume.

23. A method of operating a fuel injector having a control chamber configured to selectively receive pressurized fluid to apply a closing force to a needle valve member, the method comprising the steps of:
selectively actuating a control valve between a first position and a second position; and
moving fluid between the control chamber and the control valve through a flow passage having an insert located therein, the insert consuming at least 23 percent of the total volume defined by the flow passage.

24. The method of claim 23, further comprising the step of fluidly coupling the control chamber to a source of pressurized fuel when the control valve is in the first position.

25. The method of claim 23, further comprising the step of fluidly coupling the control chamber to a low pressure drain when the control valve is in the second position.

26. The method of claim 23, wherein the insert is a substantially cylindrical member including at least one longitudinal cutout that permits fluid to flow around the insert.

27. The method of claim 23, wherein the insert defines an internal passage that permits fluid to flow through the insert.
